(19) United States
(12) Patent Application Publication
(10) Pub. No.: US 2026/0368687 A1
(43) Pub. Date: Nov. 19, 2026

(54) Method for Predicting Checked Baggage Information of Passengers and Related Device

(71) Applicant: TRAVELSKY TECHNOLOGY LIMITED, Beijing (CN)

(72) Inventors: Yulong ZHANG, Beijing (CN); Yang LI, Beijing (CN); Zhongxing ZHAO, Beijing (CN); Zheng CHEN, Beijing (CN); Yue HAN, Beijing (CN); Yazhong LIANG, Beijing (CN); Bingqian NIU, Beijing (CN); Wenxiao LI, Beijing (CN); Chao LI, Beijing (CN); Xinran LI; Meng YU, Beijing (CN); Jiamian REN, Beijing (CN)

(21) Appl. No.: 19/137,952

(22) PCT Filed: Dec. 12, 2023
(86) PCT No.: PCT/CN2023/138046

§ 371 Date: Jun. 11, 2025

(30) Foreign Application Priority Data
Dec. 15, 2022 (CN) 202211613120.X

(51) Int. Cl. G06Q 10/083

(52) U.S. Cl. CPC G06Q 10/0838

(57) ABSTRACT

Disclosed are a method for predicting checked baggage information of passengers and related device. Departing passenger data of a current flight and historical checked baggage data of actual departing passengers are obtained, target rule data on which passenger checked baggage information prediction for the current flight needs to be based is determined, and according to the departing passenger data of the current flight, the historical checked baggage data of actual departing passengers and at least part of the target rule data, checked baggage weights of departing passengers of the current flight are predicted, such that flight load balancing is conducted on the current flight. The checked baggage weights of departing passengers of the current flight are automatically predicted according to related data and a rule, such that various drawbacks of an existing manual estimation method can be effectively overcome.

### CROSS-REFERENCES TO RELATED APPLICATION

The present disclosure is a National Stage of International Patent Application No: PCT/CN2023/138046 filed on Dec. 12, 2023, which claims the benefit of the priority of the Chinese Patent Application No. 202211613120.X, filed with the Chinese Patent Office on Dec. 15, 2022 and entitled “Method for predicting checked baggage information of passengers and related device”, which is incorporated in its entirety herein by reference.

### TECHNICAL FIELD

The present disclosure relates to the technical field of air transportation, and particularly relates to a method for predicting checked baggage information of passengers and related device.

### BACKGROUND

Flight load balancing is crucial to flight departure. Checked baggage weights of passengers of a departing flight are considered as one of the core data of load services. In order to obtain checked baggage weights of actual passengers of a loaded flight, actual checked baggage weights need to be computed through summation after all passengers check in and complete baggage check-in. However, according to an actual loading service flow, checked baggage weights of passengers of a flight need to be obtained in advance. That is, in a case that passengers do not complete check-in procedures and even no passenger checks in, the data is obtained. Thus, it is necessary to estimate the checked baggage weights of passengers of the loaded flight in advance.

An existing solution for estimating the checked baggage weights of passengers of the loaded flight is to directly estimate the weights by an operator according to personal historical experience. This solution has the following drawbacks: estimation only relies on his/her own experience of the operator, with a low reference value. This leads to an obvious difference between a value estimated manually and an actual value, thus posing risks and hidden dangers to production security. In addition, values estimated by different operators are inconsistent with great individual differences, which will also pose risks and hidden dangers to production security.

### SUMMARY

In view of that, the present disclosure provides a method for predicting checked baggage information of passengers and related device. According to departing passenger data corresponding to a current flight, historical checked baggage data of actual departing passengers and related rule data, checked baggage weights of departing passengers of the current flight are automatically determined to overcome a series of defects of an existing manual estimation method.

A specific solution is as follows:

A method for predicting checked baggage information of passengers includes:
departing passenger data corresponding to a current flight and historical checked baggage data of actual departing passengers are obtained;
target rule data on which passenger checked baggage information prediction for the current flight needs to be based is determined; and
according to the departing passenger data, the historical checked baggage data of actual departing passengers and at least part of the target rule data, checked baggage weights of departing passengers of the current flight are predicted, such that load balancing is conducted on the current flight based on the predicted checked baggage weights of departing passengers.

An apparatus for predicting checked baggage information of passengers includes:
a data obtainment module configured to obtain departing passenger data corresponding to a current flight and historical checked baggage data of actual departing passengers;
a rule determination module configured to determine target rule data on which passenger checked baggage information prediction for the current flight needs to be based; and
an information prediction module configured to predict, according to the departing passenger data, the historical checked baggage data of actual departing passengers and at least part of the target rule data, checked baggage weights of departing passengers of the current flight, such that load balancing is conducted on the current flight based on the checked baggage weights of departing passengers.

A computer-readable medium stores a computer program. The computer program includes a program code configured to execute the method for predicting checked baggage information of passengers according to the present disclosure.

A computer program product includes a computer program carried on a non-transitory computer-readable medium. The computer program includes a program code configured to execute the method for predicting checked baggage information of passengers according to the present disclosure.

According to the solution, in the method for predicting checked baggage information of passengers and related device according to the present disclosure, the departing passenger data corresponding to the current flight and the historical checked baggage data of actual departing passengers are obtained, the target rule data on which passenger checked baggage information prediction for the current flight needs to be based is determined, and according to the departing passenger data of the current flight, the historical checked baggage data of actual departing passengers and at least part of the target rule data, the checked baggage weights of departing passengers of the current flight are predicted, such that load balancing is conducted on the current flight based on the predicted checked baggage weights of departing passengers.

### BRIEF DESCRIPTION OF THE DRAWINGS

The above and other features, advantages and aspects of examples of the present disclosure will become more obvious with reference to the following specific embodiments in conjunction with the accompanying drawings. Throughout the accompanying drawings, same or similar reference numerals indicate same or similar elements. It should be understood that the accompanying drawings are schematic and components and elements are not necessarily drawn to scale.

FIG. 1 is a schematic flow diagram of a method for predicting checked baggage information of passengers according to the present disclosure;

FIG. 2 is a structural diagram of composition of an apparatus for estimating checked baggage of passengers of a loaded flight in an application instance according to the present disclosure;

FIG. 3 is another schematic flow diagram of a method for predicting checked baggage information of passengers according to the present disclosure;

FIG. 4 is yet another schematic flow diagram of a method for predicting checked baggage information of passengers according to the present disclosure;

FIG. 5 is still another schematic flow diagram of a method for predicting checked baggage information of passengers according to the present disclosure;

FIG. 6 is a schematic diagram of a component relation of all components included in the apparatus in FIG. 2 according to the present disclosure; and

FIG. 7 is a structural diagram of composition of an apparatus for predicting checked baggage information of passengers according to the present disclosure.

### DETAILED DESCRIPTION OF THE EMBODIMENTS

Examples of the present disclosure will be described in more detail below with reference to the accompanying drawings. Although some examples of the present disclosure are shown in the accompanying drawings, it should be understood that the present disclosure can be implemented in various forms and should not be construed as being limited to the examples illustrated herein. On the contrary, the examples are provided for a more thorough and complete understanding of the present disclosure. It should be understood that the drawings and the examples of the present disclosure are only for illustrative purposes, instead of limiting the protection scope of the present disclosure.

The terms “include” and “comprise” used herein and their variations are open-ended, that is, “include but not limited to” and “comprise but not limited to”. The term “based on” indicates “at least partly based on”. The term “one example” indicates “at least one example”. The term “another example” indicates “at least one another example”. The term “some examples” indicates “at least some examples”. Related definitions of other terms will be given in the following description.

It should be noted that concepts such as “first” and “second” mentioned in the present disclosure are only used to distinguish different apparatuses, modules or units, and are not used to limit an order or interdependence of functions executed by the apparatuses, modules or units.

It should be noted that modifications with “a”, “an” and “a plurality of” mentioned in the present disclosure are schematic rather than limitative, and should be understood by those skilled in the art as “one or more” unless otherwise definitely indicated in the context.

The present disclosure provides a method and apparatus for predicting checked baggage information of passengers, a computer-readable medium, and a computer program product.

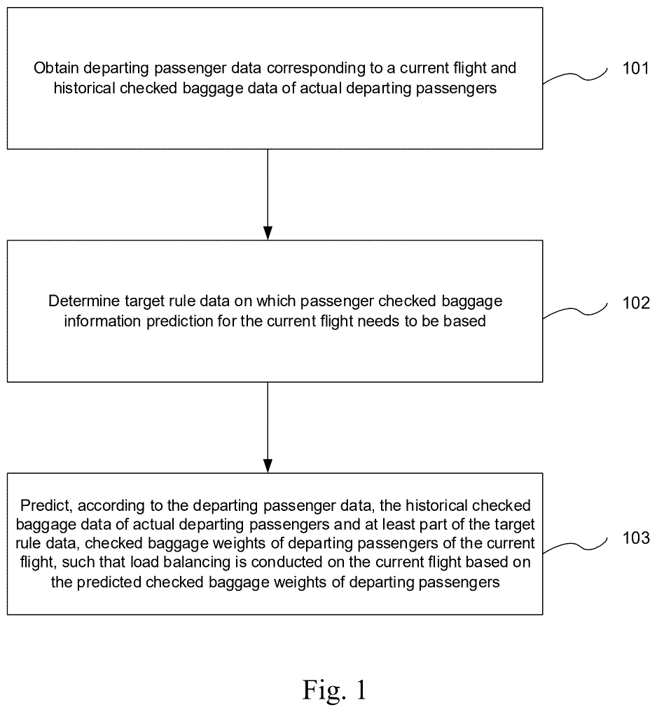

With reference to the method for predicting checked baggage information of passengers in FIG. 1, the method for predicting checked baggage information of passengers according to the present disclosure at least includes the following processing flow:

Step 101, departing passenger data corresponding to a current flight and historical checked baggage data of actual departing passengers are obtained.

Specifically, according to flight information of the current flight, the departing passenger data of the current flight may be inquired.

The flight information (Flight Info) includes, but is not limited to, some or all information such as an airline company, a flight number, a flight date, a departure station, an arrival station, an aircraft registration number, aircraft cabin layout, and a weight unit.

For instance, a multi-leg flight (1111) of an airline company, from Beijing (PEK) to Shanghai (SHA) to Guangzhou (CAN), includes two legs: Beijing-Shanghai and Shanghai-Guangzhou. The corresponding flight information is as follows:

TABLE 1

| | | | | | Aircraft | Aircraft | |
|---|---|---|---|---|---|---|---|
| Airline | Flight | | Departure | Arrival | registration | cabin | Weight |
| company | number | Flight date | station | station | number | layout | unit |
| XX | 1111 | Mar. 1, 2022 | PEK | SHA | B1234 | J12Y166 | KG |
| XX | 1111 | Mar. 1, 2022 | SHA | CAN | B4321 | F6J52Y258 | KG |

Departing passenger data (Passenger Info) includes, but is not limited to, all or some information such as an airline company, a flight number, a flight date, a departure station, an arrival station, a cabin, a passenger booking number, and a checked-in passenger number. In a flight loading process, the passenger booking number is confirmed information, and checked-in passenger number is dynamically changing with check-in of passengers.

For instance, if a departure station of the flight xx1111 is in Beijing (PEK), arrival stations of passengers in this case include Shanghai (SHA) and Guangzhou (CAN), which indicates that some passengers are from Beijing to Shanghai and some passengers are from Beijing to Guangzhou. Cabins include cabin J and cabin Y. Instances of the passenger information are as follows:

TABLE 2

| | | | | | | Passenger | Checked-in |
|---|---|---|---|---|---|---|---|
| Airline | Flight | | Departure | Arrival | | booking | passenger |
| company | number | Flight date | station | station | Cabin | number | number |
| XX | 1111 | Mar. 1, 2022 | PEK | SHA | Cabin J | 3 | 3 |
| XX | 1111 | Mar. 1, 2022 | PEK | SHA | Cabin Y | 88 | 55 |
| XX | 1111 | Mar. 1, 2022 | PEK | CAN | Cabin J | 4 | 2 |
| XX | 1111 | Mar. 1, 2022 | PEK | CAN | Cabin Y | 66 | 33 |

The historical checked baggage data of actual departing passengers corresponding to the current flight may be inquired according to a required historical data inquiry condition.

The historical checked baggage data (Baggage History) of actual departing passengers includes, but is not limited to, some or all information such as an airline company, a flight number, a flight date, a departure station, an arrival station, an actual passenger number, an actual passenger checked baggage weight, a predicted passenger checked baggage weight, a baggage weight per person, and a prediction error.

The airline company, the flight number, the flight date, the departure station and the arrival station correspond to the airline company, the flight number, the flight date, the departure station and the arrival station of the Flight Info. The actual passenger number is a checked-in passenger number collected after the flight is closed in the Passenger Info. The actual passenger checked baggage weight is a total checked baggage weight collected after the flight is closed. The predicted passenger checked baggage weight is a weight value computed by the apparatus. The baggage weight per person=the actual passenger checked baggage weight/the actual passenger number. The prediction error=|the predicted passenger checked baggage weight—the actual passenger checked baggage weight|/the actual passenger checked baggage weight.

For instance, if a departure station of the flight xx1111 is in Beijing (PEK), arrival stations of baggage in this case include Shanghai (SHA) and Guangzhou (CAN). Historical data is illustrated below:

TABLE 3

| | | | | | | Actual | Predicted | | |
|---|---|---|---|---|---|---|---|---|---|
| | | | | | | passenger | passenger | Baggage | |
| | | | | | Actual | checked | checked | weight | |
| Airline | Flight | | Departure | Arrival | passenger | baggage | baggage | per | Prediction |
| company | number | Flight date | station | station | number | weight | weight | person | error |
| XX | 1111 | Feb. 27, 2022 | PEK | SHA | 130 | 1400 | 1300 | 10.77 | 7.14% |
| XX | 1111 | Feb. 28, 2022 | PEK | SHA | 140 | 1500 | 1400 | 10.71 | 6.67% |
| XX | 1111 | Feb. 27, 2022 | PEK | CAN | 135 | 1400 | 1350 | 10.37 | 3.57% |
| XX | 1111 | Feb. 28, 2022 | PEK | CAN | 150 | 1450 | 1400 | 9.67 | 3.45% |

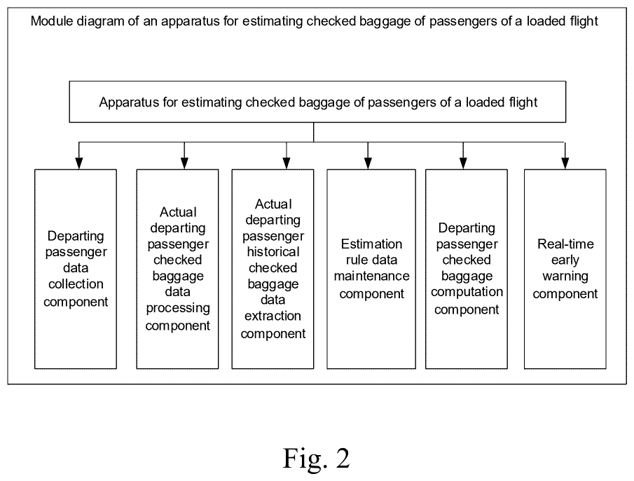

In one embodiment of this application, with reference to FIG. 2, an application instance of the disclosed method is provided, and implements an apparatus for estimating checked baggage of passengers of a loaded flight based on the disclosed method. The apparatus at least includes a departing passenger data collection component, an actual departing passenger historical checked baggage data extraction component, an estimation rule data maintenance component and a departing passenger checked baggage computation component, such that a processing process of the disclosed method is implemented based on all the components of the apparatus.

Functions of all the components are as follows:
The departing passenger data collection component has a main function of collecting departing passenger data in real time according to input flight information.
The actual departing passenger historical checked baggage data extraction component has a main function of extracting related data according to the historical checked baggage data of actual departing passengers.
The estimation rule data maintenance component has a main function of storing and maintaining data related to an estimation rule.
The departing passenger checked baggage computation component has a main function of computing checked baggage weights of departing passengers according to the departing passenger data, the historical checked baggage data of actual departing passengers and an estimation rule parameter.

In the instance, specifically, the departing passenger data collection component may be used to collect the departing passenger data in real time according to the input flight information.

Step 102, target rule data on which passenger checked baggage information prediction for the current flight needs to be based is determined.

According to the present disclosure, a corresponding estimation rule data set is stored and maintained. The estimation rule data set includes passenger checked baggage prediction rules and related parameter data.

For an instance in FIG. 2, the data related to the estimation rule may be stored and maintained based on the estimation rule data maintenance component, and the estimation rule data set may be formed. In this way, required rule data is inquired for prediction of the checked baggage weights of departing passengers.

In one embodiment of this application, the data related to the estimation rule stored and maintained by the estimation rule data maintenance component includes, but is not limited to,
11) The passenger checked baggage prediction rules (Baggage Predict Rule) include an airline company, a flight number, a departure station, an arrival station, and a prediction rule. Data related to the Baggage Predict Rule is input by a user. The prediction rule has two options, including historical data prediction (History Predict) and time series prediction (ARIMA Predict), which represent prediction directly with the data related to the historical checked baggage data of actual departing passengers (Baggage History) and time series prediction with an autoregressive integrated moving average model (ARIMA) respectively. These are two sets of independent prediction rules. Each set of prediction rules has own independent prediction parameters.

For instance, if a departure station of the flight xx1111 is in Beijing (PEK), arrival stations of baggage in this case include Shanghai (SHA) and Guangzhou (CAN). For instance,

TABLE 4

| Airline | Flight | Departure | Arrival | Prediction |
|---|---|---|---|---|
| company | number | station | station | rule |
| XX | 1111 | PEK | SHA | History Predict |
| XX | 1111 | PEK | CAN | ARIMA Predict |

In the present disclosure, the time series prediction rule includes: a prediction rule represented by a pre-created autoregressive integrated moving average (ARIMA) model. The ARIMA model is obtained through model training based on a time series data sample of the checked baggage weights of departing passengers.
12) Static data (Static Baggage Weight) of the checked baggage weights of passengers includes an airline company, a departure station, an arrival station, a cabin and a baggage weight per person, and is input by a user. The premise of prediction with the prediction rule is to have enough historical data. If the historical data is insufficient, prediction needs to be conducted directly with the static data (Static Baggage Weight) of the checked baggage weights of passengers.

For instance, if an airline company corresponding to the flight xx1111 is xx and a departure station of the flight xx1111 is in Beijing (PEK), arrival stations of baggage in this case include Shanghai (SHA) and Guangzhou (CAN), and cabins include cabin J and cabin Y. For instance,

TABLE 5

| Airline | Departure | | | Baggage weight per |
|---|---|---|---|---|
| company | station | Arrival station | Cabin | person |
| XX | PEK | SHA | Cabin J | 15 |
| XX | PEK | SHA | Cabin Y | 10 |
| XX | PEK | CAN | Cabin J | 20 |
| XX | PEK | CAN | Cabin Y | 16 |

13) Static data (Static Baggage Density) of a checked baggage density of passengers includes an airline company and a mean baggage density, and is input by a user.

For instance, an airline company corresponding to the flight xx1111 is xx. For instance,

TABLE 6

| Airline company | Mean baggage density (kg/L) |
|---|---|
| XX | 5 |

14) Static data (ULD Configuration) of a container includes an airline company, an aircraft registration number, whether it is a containerized aircraft, a default container type, a default container volume, and a default container dead-weight, and is input by a user.

For instance, if an airline company corresponding to the flight xx1111 is xx and a departure station in this case is in Beijing (PEK), an aircraft registration number is B1234. For instance,

TABLE 7

| | Aircraft | Whether it | | Default | Default |
|---|---|---|---|---|---|
| | regis- | is a contain- | Default | container | container |
| Airline | tration | erized | container | volume | dead- |
| company | number | aircraft? | type | (L) | weight |
| XX | B1234 | Yes | LD3 | 150 | 100 |

15) Official holiday data (Holiday) includes a date and whether it is an official holiday, and is input by a user. At the end of each year, holiday data of a next year has to be entered. A user only needs to input an official holiday date range, and a system may automatically generate whole-year holiday data of the next year.

For instance, a flight date corresponding to the flight xx1111 is Mar. 1, 2022. For instance,

TABLE 8

| Date | Whether it is an official holiday? |
|---|---|
| Mar. 1, 2022 | No |

If the History Predict is selected as the prediction rule in the passenger checked baggage prediction rules (Baggage Predict Rule), historical data prediction parameters (History Predict Parameters) should be included, and the historical data prediction parameters include, but are not limited to, an airline company, a flight number, a departure station, an arrival station, a date type, a percentage of historical data within 30 days, a percentage of historical data within 7 days, a percentage of historical data before a seventh day, and a minimum number of effective days of historical data, and are input by a user. The date types include workday (including Monday to Friday and excluding official holidays), weekend (including Saturday and Sunday and excluding official holidays), and holiday (official holidays). Input data needs to satisfy the following conditions: each flight (in a same airline company, flight number, departure station and arrival station) needs to include all date types; the sum of the percentage of historical data within 30 days, the percentage of historical data within 7 days and the percentage of historical data before a seventh day in each record has to be 100%; and the minimum number of effective days of historical data has to be greater than 0 and smaller than or equal to 30.

For instance, if a departure station of the flight xx1111 is in Beijing (PEK), arrival stations of baggage in this case include Shanghai (SHA) and Guangzhou (CAN). Specifically, an instance is as follows:

TABLE 9

| | | | | | | | Percentage | |
|---|---|---|---|---|---|---|---|---|
| | | | | | Percentage | Percentage | of | Minimum |
| | | | | | of | of | historical | number of |
| | | | | | historical | historical | data | effective |
| | | | | | data | data | before a | days of |
| Airline | Flight | Departure | Arrival | Date | within 30 | within 7 | seventh | historical |
| company | number | station | station | type | days | days | day | data |
| XX | 1111 | PEK | SHA | workday | 40 | 40 | 20 | 1 |
| XX | 1111 | PEK | SHA | weekend | 40 | 40 | 20 | 1 |
| XX | 1111 | PEK | SHA | holiday | 50 | 30 | 20 | 1 |
| XX | 1111 | PEK | CAN | workday | 40 | 40 | 20 | 1 |
| XX | 1111 | PEK | CAN | weekend | 40 | 40 | 20 | 1 |
| XX | 1111 | PEK | CAN | holiday | 60 | 30 | 10 | 1 |

If the ARIMA Predict is selected as the prediction rule in the Baggage Predict Rule, time series prediction parameters (ARIMA Predict Parameters) should be included, and the time series prediction parameters include an airline company, a flight number, a departure station, an arrival station, a date type, a prediction percentage by day, a prediction percentage by week, and a number of effective days of historical data, and are input by a user. The date types include workday (including Monday to Friday and excluding official holidays), weekend (including Saturday and Sunday and excluding official holidays), and holiday (official holidays). Input data needs to satisfy the following conditions: each flight (in a same airline company, flight number, departure station and arrival station) needs to include all date types; the sum of the prediction percentage by day and the prediction percentage by week in each record has to be 100%; and the minimum number of effective days of historical data has to be greater than or equal to 15 and smaller than 30.

For instance, if a departure station of the flight xx1111 is in Beijing (PEK), arrival stations of baggage in this case include Shanghai (SHA) and Guangzhou (CAN). Specifically, an instance is as follows:

TABLE 10

| | | | | | | | Minimum |
|---|---|---|---|---|---|---|---|
| | | | | | | | number of |
| | | | | | | | effective |
| | | | | | Prediction | Prediction | days of |
| Airline | Flight | Departure | Arrival | | percentage | percentage | historical |
| company | number | station | station | Date type | by day | by week | data |
| XX | 1111 | PEK | SHA | workday | 60 | 40 | 1 |
| XX | 1111 | PEK | SHA | weekend | 60 | 40 | 1 |
| XX | 1111 | PEK | SHA | holiday | 70 | 30 | 1 |
| XX | 1111 | PEK | CAN | workday | 60 | 40 | 20 |
| XX | 1111 | PEK | CAN | weekend | 60 | 40 | 20 |
| XX | 1111 | PEK | CAN | holiday | 70 | 30 | 20 |

Based on the stored and maintained estimation rule data set, the step 102 may specifically determine the target rule data on which passenger checked baggage information prediction for the current flight needs to be based from the estimation rule data set with the departing passenger checked baggage computation component, such that the checked baggage weights of departing passengers of the current flight are predicted later based on the target rule data. The process may further be implemented as follows:
21) According to the flight information of the current flight, a target prediction rule corresponding to the current flight in a pre-configured estimation rule data set is determined.

In one embodiment of this application, with the departing passenger checked baggage computation component, the passenger checked baggage prediction rules (Baggage Predict Rule) are searched for according to the airline company, the flight number, the departure station and the arrival station in the current flight information (Flight Info), and the target prediction rule is obtained.

For instance, if a departure station of the flight xx1111 is in Beijing (PEK), arrival stations of baggage in this case include Shanghai (SHA) and Guangzhou (CAN). Inquiry results are as follows:

TABLE 11

| Airline | Flight | Departure | Arrival | |
|---|---|---|---|---|
| company | number | station | station | Prediction rule |
| XX | 1111 | PEK | SHA | History Predict |
| XX | 1111 | PEK | CAN | ARIMA Predict |

22) In response to determining that the target prediction rule is a historical data prediction rule in the passenger checked baggage prediction rules, whether a historical data prediction condition is satisfied is determined. If the historical data prediction condition is satisfied, it is determined that the target rule data includes the historical data prediction rule and a corresponding rule parameter in the estimation rule data set. If the historical data prediction condition is not satisfied, it is determined that the target rule data includes static data of the checked baggage weights of passengers in the estimation rule data set.

For instance, if the prediction rule is the historical data prediction rule (History Predict), whether the historical data prediction condition is satisfied may be determined according to the following process, and the corresponding target rule data may be determined for a case that the historical data prediction condition is satisfied or not:
2.1, Effective days (effective Days) are obtained as follows: according to the airline company, the flight number, the departure station, the arrival station and [flight date-30, flight date-1] of the current flight information (Flight Info), the effective days are extracted from the actual departing passenger historical checked baggage data extraction component.
2.2, The date type (date Type) is obtained as follows: according to the flight date of the current flight information (Flight Info), holiday is searched for, and whether the date type is holiday is determined. If the date type is not holiday, whether the date type is workday or weekend is determined.
2.3, The minimum number (valid Data Min) of effective days of historical data is obtained as follows: according to the airline company, the flight number, the departure station, the arrival station and the date type (date Type) of the current flight information (Flight Info), History Predict Parameters are searched for, and the minimum number of effective days of historical data is obtained.
2.4, If the effective Days>=valid Data Min, prediction is conducted according to historical data. That is, in this case, it is determined that the target rule data includes the historical data prediction rule and the corresponding rule parameter in the estimation rule data set. Otherwise, prediction is conducted according to the static data (Static Baggage Weight) of the checked baggage weights of passengers. That is, in this case, it is determined that the target rule data includes the static data of the checked baggage weights of passengers in the estimation rule data set.

For instance, if a departure station of the flight xx1111 is in Beijing (PEK), the prediction rule is History Predict when an arrival station of baggage is in SHA, and following processing is further executed:

Effective days are obtained as follows: according to xx, 1111, PEK, SHA, and 2022 Jan. 30-2022 Feb. 28, the historical data is inquired. The qualified historical data is as follows, with two records in total, as shown in the following table, so effective Days=2.

TABLE 12

| | | | | | | Actual | Predicted | | |
|---|---|---|---|---|---|---|---|---|---|
| | | | | | | passenger | passenger | Baggage | |
| | | | | | Actual | checked | checked | weight | |
| Airline | Flight | Flight | Departure | Arrival | passenger | baggage | baggage | per | Prediction |
| company | number | date | station | station | number | weight | weight | person | error |
| XX | 1111 | Feb. 27, 2022 | PEK | SHA | 130 | 1400 | 1300 | 10.77 | 7.14% |
| XX | 1111 | Feb. 28, 2022 | PEK | SHA | 140 | 1500 | 1400 | 10.71 | 6.67% |

The date type is obtained as follows: the flight date is Mar. 1, 2022. Holiday is searched for. If the date type is not holiday, determination is continued. Mar. 1, 2022 is Tuesday, so date Type=workday is finally obtained.

The minimum number of effective days of historical data is obtained as follows: according to xx, 1111, PEK, SHA and workday, the History Predict Parameters are searched for. Results are as follows, with valid Data Min=1.

TABLE 13

| | | | | | | | Percentage | |
|---|---|---|---|---|---|---|---|---|
| | | | | | Percentage | Percentage | of | Minimum |
| | | | | | of | of | historical | number of |
| | | | | | historical | historical | data | effective |
| | | | | | data | data | before a | days of |
| Airline | Flight | Departure | Arrival | | within | within | seventh | historical |
| company | number | station | station | Date type | 30 days | 7 days | day | data |
| XX | 1111 | PEK | SHA | workday | 40 | 40 | 20 | 1 |

effective Days=2, valid Data Min=1, and effective Days>valid Data Min. In this case, prediction is conducted according to the historical data, and accordingly, it is determined that the target rule data includes the historical data prediction rule and the corresponding rule parameter in the estimation rule data set.
23) In response to determining that the target prediction rule is the time series prediction rule in the passenger checked baggage prediction rules, whether the time series prediction condition is satisfied is determined. If the time series prediction condition is satisfied, it is determined that the target rule data includes the time series prediction rule and the corresponding rule parameter in the estimation rule data set. If the time series prediction condition is not satisfied, it is determined that the target rule data includes the static data of the checked baggage weights of passengers in the estimation rule data set.

For instance, if the prediction rule is the time series prediction rule (ARIMA Predict), whether the time series prediction condition is satisfied may be determined according to the following process, and the corresponding target rule data may be determined for a case that the time series prediction condition is satisfied or not:
3.1, Effective days predicted by day (effective By Day) are obtained as follows: according to the airline company, the flight number, the departure station, the arrival station and [flight date-30, flight date-1] of the current flight information (Flight Info), the effective days are extracted from the actual departing passenger historical checked baggage data extraction component.
3.2, Effective days predicted by week (effective By Week) are obtained as follows: according to the airline company, the flight number, the departure station, the arrival station and dates corresponding to thirty identical weeks before the flight date of the current flight information (Flight Info), the effective days are extracted from the actual departing passenger historical checked baggage data extraction component.
3.3, The date type (date Type) is obtained as follows: according to the flight date of the current flight information (Flight Info), holiday is searched for, and whether the date type is holiday is determined. If the date type is not holiday, whether the date type is workday or weekend is determined.
3.4, The minimum number (valid Data Min) of effective days of historical data is obtained as follows: according to the airline company, the flight number, the departure station, the arrival station and the date type (date Type) of the current flight information (Flight Info), ARIMA Predict Parameters are searched for, and the minimum number of effective days of historical data is obtained.
3.5, If effective By Day>=valid Min and effective By Week>=valid Data Min, prediction is conducted according to the time series. That is, in this case, it is determined that the target rule data includes the time series prediction rule and the corresponding rule parameter in the estimation rule data set. Otherwise, prediction is conducted according to the static data (Static Baggage Weight) of the checked baggage weights of passengers. That is, in this case, it is determined that the target rule data includes the static data of the checked baggage weights of passengers in the estimation rule data set.

For instance, if a departure station of the flight xx1111 is in Beijing (PEK), the prediction rule is ARIMA Predict when an arrival station of baggage is in CAN, and following processing is further executed:

Effective days predicted by day are obtained as follows: according to xx, 1111, PEK, CAN, and 2022 Jan. 30-2022/2/28, the historical data is inquired. The qualified historical data is as follows, with two records in total, as shown in the following table, so effective By Day=2.

TABLE 14

| | | | | | | Actual | Predicted | | |
|---|---|---|---|---|---|---|---|---|---|
| | | | | | | passenger | passenger | Baggage | |
| | | | | | Actual | checked | checked | weight | |
| Airline | Flight | | Departure | Arrival | passenger | baggage | baggage | per | Prediction |
| company | number | Flight date | station | station | number | weight | weight | person | error |
| XX | 1111 | Feb. 27, 2022 | PEK | CAN | 135 | 1400 | 1350 | 10.37 | 3.57% |
| XX | 1111 | Feb. 28, 2022 | PEK | CAN | 150 | 1450 | 1400 | 9.67 | 3.45% |

Effective days predicted by week are obtained as follows: according to xx, 1111, PEK, CAN, and {Aug. 3, 2021, Aug. 10, 2021, . . . . Feb. 15, 2022, Feb. 22, 2022}, the historical data is inquired. If qualified historical data does not exist, effective By Week=0.

The date type is obtained as follows: the flight date is Mar. 1, 2022. Holiday is searched for. If the date type is not holiday, determination is continued. Mar. 1, 2022 is Tuesday, so date Type=workday is finally obtained.

The minimum number of effective days of historical data is obtained as follows: according to xx, 1111, PEK, CAN and workday, the ARIMA Predict Parameters are searched for. Results are as follows, with valid Data Min=20.

TABLE 15

| | | | | | | | Minimum |
|---|---|---|---|---|---|---|---|
| | | | | | | | number of |
| | | | | | | | effective |
| | | | | | Prediction | Prediction | days of |
| Airline | Flight | Departure | Arrival | | percentage | percentage | historical |
| company | number | station | station | Date type | by day | by week | data |
| XX | 1111 | PEK | CAN | workday | 60 | 40 | 20 |

effective By Day=2, effective By Week=0, valid Data Min=20, effective By Day<valid Data Min, and effective By Week<valid Data Min. In this case, prediction is conducted according to the static data (Static Baggage Weight) of the checked baggage weights of passengers, and accordingly, it is determined that the target rule data includes the static data of the checked baggage weights of passengers in the estimation rule data set.

Step 103, according to the departing passenger data, the historical checked baggage data of actual departing passengers and at least part of the target rule data, checked baggage weights of departing passengers of the current flight are predicted, such that load balancing is conducted on the current flight based on the predicted checked baggage weights of departing passengers.

Then, according to the departing passenger data corresponding to the current flight, the historical checked baggage data of actual departing passengers and at least part of the target rule data, checked baggage weights of departing passengers of the current flight are predicted. The predicted value is specifically a predicted total checked baggage weight of the departing passengers of the current flight.

The process may further be implemented as follows:
31) In response to determining that the target rule data includes the historical data prediction rule and the corresponding rule parameter, historical parameter data required by the historical data prediction rule is extracted from the historical checked baggage data of actual passengers. The checked baggage weights of departing passengers of the current flight are predicted according to the departing passenger data, the historical parameter data, and the historical data prediction rule and the corresponding rule parameter.

For an instance in FIG. 2, the actual departing passenger historical checked baggage data extraction component may be specifically used to extract the historical parameter data required by the historical data prediction rule from the historical checked baggage data of actual passengers corresponding to the current flight, such that the required historical parameter data may be obtained and includes, but is not limited to:

A mean baggage weight per person of historical data within 30 days (avgWeight30) is as follows: according to the airline company, the flight number, the departure station, the arrival station and [flight date-30, flight date-1] of the current flight information (Flight Info), the mean baggage weight per person is extracted with the actual departing passenger historical checked baggage data extraction component.

Effective days of historical data within 7 days (effective7) are as follows: according to the airline company, the flight number, the departure station, the arrival station and [flight date-7, flight date-1] of the current flight information (Flight Info), the effective days are extracted with the actual departing passenger historical checked baggage data extraction component.

A mean baggage weight per person of historical data within 7 days (avgWeight7) is as follows: according to the airline company, the flight number, the departure station, the arrival station and [flight date-7, flight date-1] of the current flight information (Flight Info), the mean baggage weight per person is extracted with the actual departing passenger historical checked baggage data extraction component.

Effective days of historical data before a seventh day (effectiveAt7) are as follows: according to the airline company, the flight number, the departure station, the arrival station and flight date-7 of the current flight information (Flight Info), the effective days are extracted with the actual departing passenger historical checked baggage data extraction component.

A mean baggage weight per person of historical data before a seventh day (avgWeightAt7) is as follows: according to the airline company, the flight number, the departure station, the arrival station and flight date-7 of the current flight information (Flight Info), the mean baggage weight per person is extracted with the actual departing passenger historical checked baggage data extraction component.

In addition, for prediction of the checked baggage weights of departing passengers of the current flight through this method, related rule parameters of the historical data prediction rule further need to be obtained from the estimation rule data set, and include, but are not limited to:

The historical data prediction parameters are as follows: according to the airline company, the flight number, the departure station, the arrival station and the date type (date Type) of the current flight information (Flight Info), the History Predict Parameters are searched for, and the percentage (percentage30) of historical data within 30 days, the percentage (percentage7) of historical data within 7 days and the percentage (percentageAt7) of historical data before a seventh day are obtained.

Moreover, a booking number (book Num) in departing passenger data of the current flight further needs to be obtained as follows: according to the airline company, the flight number, the flight date, the departure station and a passenger arrival station of the current flight information (Flight Info), the departing passenger data (Passenger Info) is searched for qualified records, and a number of booked passengers of all records is accumulated.

Based on the above description, the checked baggage weights (bag Est (estimated) Weight) of departing passengers of the current flight are computed with the departing passenger checked baggage computation component according to the historical data prediction rule and various data obtained, and the checked baggage weights of departing passengers are predicted. An illustrative prediction process is as follows:

In a case that effective7=0, and bag Es Weight=avgWeight30*book Num;

```
in a case that effective7>0, effectiveAt7-0, and
  bagEstWeight=(avgWeight30*percentage30+avgWeight7*percentage7)/
  (percentage30+percentage7)*bookNum; or
in a case that effective7>0, effectiveAt7>0, and
bagEstWeight-(avgWeight30*percentage30+avgWeight7*percentage7+
avgWeightAt7*percentageAt7)*bookNum;
```

for instance, if a departure station of the flight xx1111 is in Beijing (PEK), the checked baggage weights (bag Est Weight) of passengers need to be computed according to the historical data when the arrival station of baggage is in SHA. That is, the checked baggage weights of departing passengers of the current flight need to be predicted based on the historical data prediction rule. The process is as follows:

The mean baggage weight per person of historical data within 30 days (avgWeight30) is obtained as follows: according to xx, 1111, PEK, SHA, and 2022 Jan. 30-2022/2/28, the historical data is inquired. The qualified historical data is as follows:

avgWeight30=(10.77+10.71)/2=10.74.

TABLE 16

| | | | | | | Actual | Predicted | | |
|---|---|---|---|---|---|---|---|---|---|
| | | | | | | passenger | passenger | Baggage | |
| | | | | | Actual | checked | checked | weight | |
| Airline | Flight | | Departure | Arrival | passenger | baggage | baggage | per | Prediction |
| company | number | Flight date | station | station | number | weight | weight | person | error |
| XX | 1111 | Feb. 27, 2022 | PEK | SHA | 130 | 1400 | 1300 | 10.77 | 7.14% |
| XX | 1111 | Feb. 28, 2022 | PEK | SHA | 140 | 1500 | 1400 | 10.71 | 6.67% |

The effective days of historical data within 7 days (effective7) are obtained as follows: according to xx, 1111, PEK, SHA, and 2022 Feb. 22-2022/2/28, the historical data is inquired. The qualified historical data is consistent with that in 1) as follows: effective7=2.

The mean baggage weight per person of historical data within 7 days (avgWeight7) is obtained as follows: according to xx, 1111, PEK, SHA, and 2022 Feb. 22-2022/2/28, the historical data is inquired. The qualified historical data is consistent with that in 1) as follows:

avgWeight7=(10.77+10.71)/2=10.74.

The effective days of historical data before the seventh day (effectiveAt7) are obtained as follows: according to xx, 1111, PEK, SHA, and 2022 Feb. 22, the historical data is inquired. If the qualified historical data does not exist, effectiveAt7=0.

The mean baggage weight per person of historical data before the seventh day (avgWeightAt7) is obtained as follows: according to xx, 1111, PEK, SHA, and 2022 Feb. 22, the historical data is inquired. If the qualified historical data does not exist, avgWeightAt7 has no value.

The historical data prediction parameters are obtained as follows: according to xx, 1111, PEK, SHA and workday, the History Predict Parameters are searched for, and the following records are obtained. That is, percentage30-40%, percentage7=40%, and percentageAt7=20%.

TABLE 17

| | | | | | | | Percentage | |
|---|---|---|---|---|---|---|---|---|
| | | | | | Percentage | Percentage | of | Minimum |
| | | | | | of | of | historical | number of |
| | | | | | historical | historical | data | effective |
| | | | | | data | data | before a | days of |
| Airline | Flight | Departure | Arrival | | within | within | seventh | historical |
| company | number | station | station | Date type | 30 days | 7 days | day | data |
| XX | 1111 | PEK | SHA | workday | 40 | 40 | 20 | 1 |

The booking number (book Num) is obtained as follows: according to xx, 1111, Mar. 1, 2022, PEK and SHA, the Passenger Info is searched for, and the following records are obtained. That is, book Num=3+88=91.

TABLE 18

| | | | | | | Passenger | Checked-in |
|---|---|---|---|---|---|---|---|
| Airline | Flight | | Departure | Arrival | | booking | passenger |
| company | number | Flight date | station | station | Cabin | number | number |
| XX | 1111 | Mar. 1, 2022 | PEK | SHA | Cabin J | 3 | 3 |
| XX | 1111 | Mar. 1, 2022 | PEK | SHA | Cabin Y | 88 | 55 |

If bagEstWeight:effective7=2 is computed, effective7>0 and effectiveAt7=0. Thus, bagEstWeight=(avgWeight30*percentage30+avgWeight7*percentage7)/(percentage30+percentage7)*bookNum=(10.74*40%+10.74*40%)/(40%+40%)*91=977.34.
32) In response to determining that the target rule data includes the time series prediction rule and the corresponding rule parameter, historical time series parameter data required by the time series prediction rule is extracted from the historical checked baggage data of actual passengers, and the checked baggage weights of departing passengers of the current flight are predicted according to the departing passenger data, the historical time series parameter data, and the time series prediction rule and the corresponding rule parameter.

For an instance in FIG. 2, in the method 32), the actual departing passenger historical checked baggage data extraction component may be specifically used to extract the historical time series parameter data required by the time series prediction rule from the historical checked baggage data of actual passengers corresponding to the current flight, and in a case that the historical time series parameter data is missed, a time series is added through a linear difference method, and includes, but is not limited to:

A time series (time Series By Day) of a baggage weight per person predicted by day is obtained as follows: according to the airline company, the flight number, the departure station, the arrival station and [flight date-30, flight date-1] of the current flight information (Flight Info), the time series of the baggage weight per person is extracted from the actual departing passenger historical checked baggage data extraction component, and a time series is added through a linear difference method. If there is a lack of data at a head and a tail of the time series, most recent and effective data is directly used.

For instance, the extracted time series is as follows: data from Jan. 1, 2020 to Jan. 6, 2020 needs to be obtained, and data exists in only two days in a database, that is, Jan. 2, 2020 and Jan. 5, 2020. Thus, other data needs to be added.

TABLE 19

| Jan. 2, 2020 | Jan. 5, 2020 |
|---|---|
| 15 | 13 |

Firstly, missing dates are added, and the following data is obtained:

TABLE 20

| Jan. 1, | Jan. 2, | Jan. 3, | Jan. 4, | Jan. 5, | Jan. 6, |
|---|---|---|---|---|---|
| 2020 | 2020 | 2020 | 2020 | 2020 | 2020 |
| Value1 | 15 | Value2 | Value3 | 13 | Value4 |

Then, data missing at a head and a tail is added. Value1 is head data, and effective data closest to the head data is data of Jan. 2, 2020, so Value 1=15, and similarly Value4=13. Data added at the head and tail is as follows:

TABLE 21

| Jan. 1, | Jan. 2, | Jan. 3, | Jan. 4, | Jan. 5, | Jan. 6, |
|---|---|---|---|---|---|
| 2020 | 2020 | 2020 | 2020 | 2020 | 2020 |
| 15 | 15 | Value2 | Value3 | 13 | 13 |

Finally, data missing in the middle is added through linear interpolation, and Value2 is computed as follows: (2020 Jan. 5-2020 Jan. 3)/(2020 Jan. 3-2020 Jan. 2)=(13-Value2)/(Value2-15), that is, 2/1=(13-Value2)/(Value2-15). In this way, Value2=43/3=14.33 is computed, and similarly, Value3=41/3=13.67 may be computed. A final time series after data addition is as follows:

TABLE 22

| Jan. 1, | Jan. 2, | Jan. 3, | Jan. 4, | Jan. 5, | Jan. 6, |
|---|---|---|---|---|---|
| 2020 | 2020 | 2020 | 2020 | 2020 | 2020 |
| 15 | 15 | 14.33 | 13.67 | 13 | 13 |

A time series (time Series By Week) of a baggage weight per person predicted by week is obtained as follows: according to the airline company, the flight number, the departure station, the arrival station and dates corresponding to thirty identical weeks before the flight date of the current flight information (Flight Info), the time series of the baggage weight per person is extracted from the actual departing passenger historical checked baggage data extraction component, and a time series is added through a linear difference method. If there is a lack of data at a head and a tail of the time series, most recent and effective data is directly used.

For instance, the extracted time series is as follows: data from {Mar. 1, 2022, Mar. 8, 2022, Mar. 15, 2022, Mar. 22, 2022, Mar. 29, 2022} needs to be obtained, and data exists in only two days in a database, that is, Mar. 15, 2022 and Mar. 29, 2022. Thus, other data needs to be added.

TABLE 23

| Mar. 15, 2022 | Mar. 29, 2022 |
|---|---|
| 15 | 13 |

With reference to an instance of prediction by day, the following data is obtained after addition:

TABLE 24

| Mar. 1, | Mar. 8, | Mar. 15, | Mar. 22, | Mar. 29, |
|---|---|---|---|---|
| 2022 | 2022 | 2022 | 2022 | 2022 |
| 15 | 15 | 15 | 14 | 13 |

In addition, for prediction of the checked baggage weights of departing passengers of the current flight through this method, related rule parameters of the time series prediction rule further need to be obtained from the estimation rule data set, and include, but are not limited to:

The time series prediction parameters are obtained as follows: according to the airline company, the flight number, the departure station, the arrival station and the date type (date Type) of the current flight information (Flight Info), the ARIMA Predict Parameters are searched for, and the prediction percentage by day (percentage By Day) and the prediction percentage by week (percentage By Week) are obtained.

Moreover, the booking number in the departing passenger data of the current flight further needs to be obtained as follows: according to the airline company, the flight number, the flight date, the departure station and the passenger arrival station of the current flight information (Flight Info), the departing passenger data (Passenger Info) is searched for qualified records, and the number of booked passengers of all records is accumulated.

Based on the above description, the checked baggage weights (bag Est Weight) of departing passengers of the current flight are computed with the departing passenger checked baggage computation component according to the time series prediction rule and various data obtained, and the checked baggage weights of departing passengers are predicted. An illustrative prediction process is as follows:

Parameters P1, D1 and Q1 of the ARIMA model predicted by day are computed as follows: D1 has a range of 1 and 2, P1 has a range of 1-5, and Q1 has a range of 1-5. All the values of P1, D1 and Q1 are traversed. Data of the first 25 days of the time Series By Day and the corresponding model parameters P1, D1 and Q1 are substituted into the ARIMA model so as to predict the checked baggage weights of passengers of last 5 days, and a predicted value is compared with an actual value, such that a group of P1, D1 and Q1 with a minimum error sum of squares is searched for.

With a simple instance, the following time series is provided:

TABLE 25

| Mar. 1, | Mar. 8, | Mar. 15, | Mar. 22, | Mar. 29, |
|---|---|---|---|---|
| 2022 | 2022 | 2022 | 2022 | 2022 |
| 13 | 15 | 15 | 16 | 15 |

Assuming D1=1, P1 has a range of 2 and 3, and Q1 has a range of 1 and 2. All values of P1, D1 and Q1 are traversed. First three values of the time series in the case and the corresponding model parameters P1, D1 and Q1 are substituted into the ARIMA model so as to predict data of last 2 days. Results are as follows:

TABLE 26

| | | | Mar. 22, 2022 | Mar. 29, 2022 |
|---|---|---|---|---|
| D1 value | P1 value | Q1 value | Prediction result | Prediction result |
| 1 | 2 | 1 | 15 | 15 |
| 1 | 3 | 1 | 16 | 15.5 |
| 1 | 2 | 2 | 16 | 17 |
| 1 | 3 | 2 | 15 | 16 |

A predicted error sum of squares corresponding to each group of P1, D1 and Q1 is computed. Computation results are as follows: it may be seen that a minimum predicted error sum of squares is achieved when D1=1, P1=3 and Q1=1, so D1=1, P1-3 and Q1-1 are finally determined.

TABLE 27

| D1 value | P1 value | Q1 value | Predicted error sum of squares |
|---|---|---|---|
| 1 | 2 | 1 | (15-16)\hat{ }2 + (15-15)\hat{ }2 = 1 |
| 1 | 3 | 1 | (16-16)\hat{ }2 + (15.5-15)\hat{ }2 = 0.25 |
| 1 | 2 | 2 | (16-16)\hat{ }2 + (17-15)\hat{ }2 = 4 |
| 1 | 3 | 2 | (15-16)\hat{ }2 + (16-15)\hat{ }2 = 2 |

Parameters P2, D2 and Q2 of the ARIMA model predicted by week are computed as follows: D2 has a range of 1 and 2, P2 has a range of 1-5, and Q2 has a range of 1-5. All the values of P2, D2 and Q2 are traversed. Data of the first 25 days of the time Series By Week and the corresponding model parameters P2, D2 and Q2 are substituted into the ARIMA model so as to predict the checked baggage weights of passengers of last 5 days, and a predicted value is compared with an actual value, such that a group of P2, D2 and Q2 with a minimum error sum of squares is searched for.

The baggage weight per person predicted by day (avg (average) Weight By Day) is computed as follows: data of the time Series By Day and the corresponding model parameters P1, D1 and Q1 are substituted into the ARIMA model so as to predict the baggage weight per person of the current flight.

The baggage weight per person predicted by week (avg Weight By Week) is computed as follows: data of the time Series By Week and the corresponding model parameters P2, D2 and Q2 are substituted into the ARIMA model so as to predict the baggage weight per person of the current flight.

Based on the time series prediction rule, the bag Est Weight is computed as follows:

bagEstWeight=(avgWeightByDay*percentageByDay+avgWeightByWeek*percentageByWeek)*bookNum.
33) In response to determining that the target rule data includes the static data of the checked baggage weights of passengers, checked baggage weights of departing passengers of the current flight are predicted according to the departing passenger data and the static data of the checked baggage weights of passengers.

In this way, in one embodiment of this application, the required static data of the checked baggage weights of passengers and the required departing passenger data may be specifically obtained, and include, but are not limited to:

Baggage weights per person (avg Weight) of different cabins are obtained as follows: according to the airline company, the departure station and the arrival station of the current flight information (Flight Info), the static data (Static Baggage Weight) of the checked baggage weights of passengers is searched for, and the corresponding cabin and baggage weight per person are obtained.

Booking numbers (book Num) of different cabins are obtained as follows: according to the airline company, the flight number, the flight date, the departure station and the passenger arrival station of the current flight information (Flight Info), the departing passenger data (Passenger Info) is searched for the corresponding cabin and passenger booking number.

Based on the above description, the checked baggage weights (bag Est Weight) of departing passengers of the current flight are computed with the departing passenger checked baggage computation component according to the obtained departing passenger data and the static data of the checked baggage weights of passengers, and the checked baggage weights of departing passengers are predicted.

Specifically, the bag Est Weight is computed to be the sum of avg Weight*book Num of all same cabins.

For instance, if a departure station of the flight xx1111 is in Beijing (PEK), the checked baggage weights (bag Est Weight) of passengers need to be computed according to the static data of the checked baggage weights of passengers when the arrival station of baggage is in CAN. The process is as follows:

Baggage weights per person (avg Weight) of different cabins are obtained as follows: according to xx, PEK and CAN, the Static Baggage Weight is searched for, and the following records are obtained.

TABLE 28

| Airline | Departure | Arrival | | Baggage weight |
|---|---|---|---|---|
| company | station | station | Cabin | per person |
| XX | PEK | CAN | Cabin J | 20 |
| XX | PEK | CAN | Cabin Y | 16 |

The booking numbers (book Num) of different cabins are obtained as follows: according to xx, 1111, Mar. 1, 2022, PEK and CAN, searching is conducted, and the following records are obtained:

TABLE 29

| | | | | | | Passenger | Checked-in |
|---|---|---|---|---|---|---|---|
| Airline | Flight | | Departure | Arrival | | booking | passenger |
| company | number | Flight date | station | station | Cabin | number | number |
| XX | 1111 | Mar. 1, 2022 | PEK | CAN | Cabin J | 4 | 2 |
| XX | 1111 | Mar. 1, 2022 | PEK | CAN | Cabin Y | 66 | 33 |

bag Est Weight: bag Est Weight=20*4+16*66=1136 is computed.

According to the solution, in the method for predicting checked baggage information of passengers according to the present disclosure, the departing passenger data corresponding to the current flight and the historical checked baggage data of actual departing passengers are obtained, the target rule data on which passenger checked baggage information prediction for the current flight needs to be based is determined, and according to the departing passenger data of the current flight, the historical checked baggage data of actual departing passengers and at least part of the target rule data, checked baggage weights of departing passengers of the current flight are predicted, such that load balancing is conducted on the current flight based on the predicted checked baggage weights of departing passengers. According to the present disclosure, the checked baggage weights of departing passengers of the current flight are automatically predicted according to related data and a rule, such that various drawbacks of an existing manual estimation method can be effectively overcome. Prediction is based on comprehensive reference data, such that reference value of a predicted value of the checked baggage weights of departing passengers is improved, the predicted value is closer to the actual value, deviations of prediction results cannot be caused by individual differences, and risks and hidden dangers for production security are avoided.

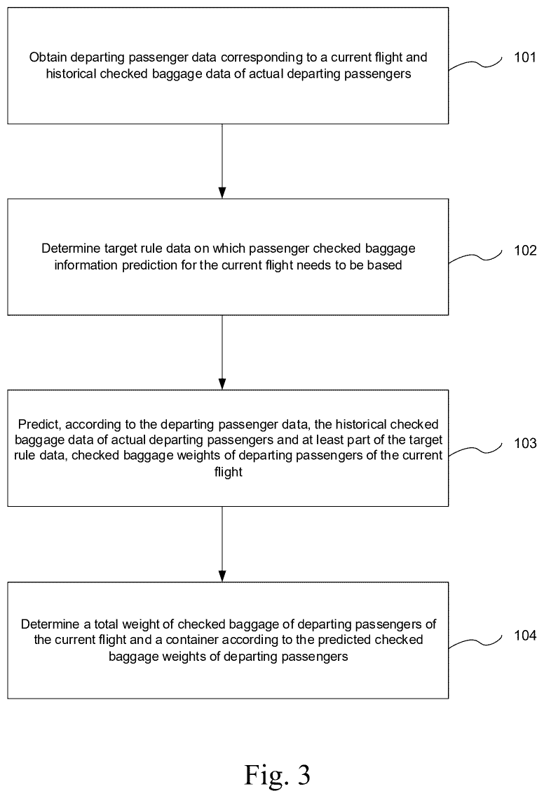

In an example, in one embodiment of this application, reference is made to a flow diagram of a method for predicting checked baggage information of passengers as shown in FIG. 3. The method for predicting checked baggage information of passengers according to the present disclosure may further include the following step:

Step 104, a total weight of checked baggage of departing passengers of the current flight and a container is determined according to the predicted checked baggage weights of departing passengers.

In a case that the current flight is a containerized aircraft, the total weight of the checked baggage of departing passengers and the container is the sum of the checked baggage weights of departing passengers and a container weight. In a case that the current flight is a non-containerized aircraft, the total weight of the checked baggage of departing passengers and the container is the checked baggage weights of departing passengers.

In one embodiment of this application, the static data (ULD Configuration) of the container may be specifically inquired according to the airline company and the aircraft registration number in the flight information (Flight Info) corresponding to the current flight, such that whether the current flight is the containerized aircraft is determined. If the current flight is the containerized aircraft, the container weight (uld (Unit Load Device) Est Weight) further needs to be additionally computed, and the total weight of the checked baggage of departing passengers and the container is computed according to the predicted checked baggage weights of departing passengers and the container weight. That is, total Est Weight=bag Est Weight+uld Est Weight. If the current flight is not the containerized aircraft, the total weight of the checked baggage of departing passengers and the container is the checked baggage weights of departing passengers. That is, total Est Weight-bag Est Weight.

For instance, if the airline company corresponding to the flight xx1111 is xx and the departure station of the flight xx1111 is in Beijing (PEK), the aircraft registration number is B1234. According to xx and B1234, the ULD Configuration is searched for, and the following records are obtained. The flight is the containerized aircraft, so the container weight needs to be computed additionally.

TABLE 30

| | Aircraft | Whether it | | Default | Default |
|---|---|---|---|---|---|
| | regis- | is a contain- | Default | container | container |
| Airline | tration | erized | container | volume | dead- |
| company | number | aircraft? | type | (L) | weight |
| XX | B1234 | Yes | LD3 | 150 | 100 |

An illustrative computation flow of the container weight (uld Est Weight) is as follows:

A checked baggage density (baggage Density) of the passenger is obtained as follows: according to the airline company of the current flight information (Flight Info), the static data (Static Baggage Density) of the checked baggage density of the passenger is searched for, and a corresponding mean baggage density is obtained.

A container volume (uld Per Volume) and a dead-weight (uld Per Weight) are obtained as follows: according to the airline company and the aircraft registration number of the current flight information (Flight Info), the static data (ULD Configuration) of the container is searched for, and the default container volume and the default container dead-weight are obtained.

A required container number (uld Num) is computed as follows: uld Num=(bag Est Weight/baggage Density)/uld Per Volume. A computation result is rounded up to an integer.

The container weight (uld Est Weight) is computed as follows: uld Est Weight=uld Num*uld Per Weight.

In the example, the total weight of the checked baggage of departing passengers of the current flight and the container is determined, such that a data basis may be provided for load balancing of the current flight. In addition, the checked baggage weights of departing passengers of the current flight may be automatically predicted according to the related data and the rule when the total weight of the checked baggage of departing passengers and the container is determined. Reference value of the predicted value of the checked baggage weights of departing passengers is improved, and accordingly, reference value of the total weight of the checked baggage of departing passengers and the container is improved. Thus, the predicted value is closer to the actual value, and risks and hidden dangers posed to production security are avoided.

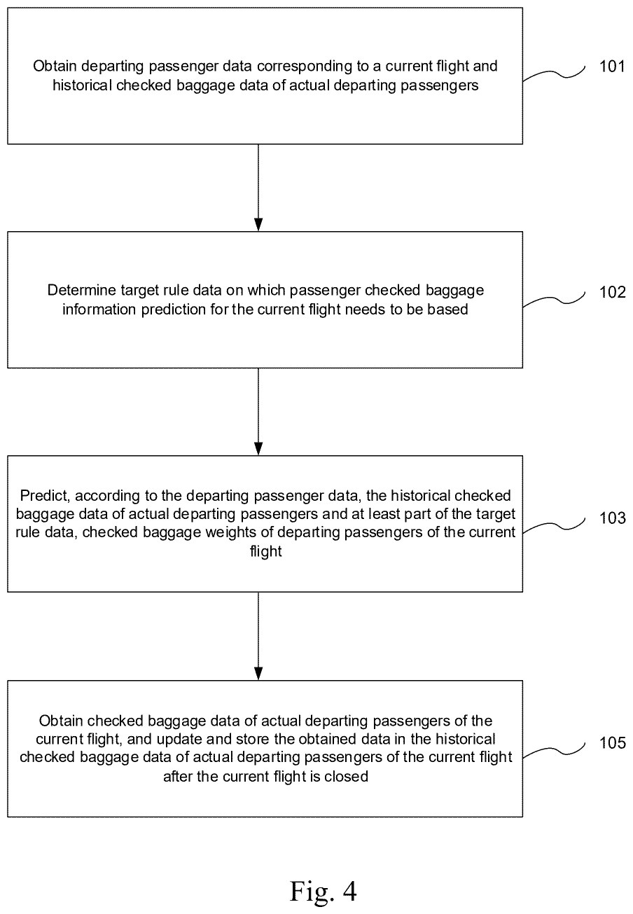

In an example, in one embodiment of this application, reference is made to a flow diagram of a method for predicting checked baggage information of passengers as shown in FIG. 4. The method for predicting checked baggage information of passengers according to the present disclosure may further include the following step:

Step 105, checked baggage data of actual departing passengers of the current flight is obtained, and the obtained data is updated and stored in the historical checked baggage data of actual departing passengers of the current flight after the current flight is closed.

For an instance in FIG. 2, an actual departing passenger checked baggage data processing component may be further additionally arranged in an apparatus for estimating checked baggage of passengers of a loaded flight, which is implemented based on the disclosed method. Specifically, as shown in FIG. 2, the component may be used to collect the checked baggage data of passengers in real time, and store the related data into the historical checked baggage data of actual departing passengers after the flight is closed.

For instance, if the current flight xx1111 corresponds to a date Mar. 1, 2022, the checked baggage data of actual departing passengers of the current flight on Mar. 1, 2022 may be updated to Baggage History after the flight is closed, and the updated Baggage History data is as follows:

TABLE 31

| | | | | | | Actual | Predicted | | |
|---|---|---|---|---|---|---|---|---|---|
| | | | | | | passenger | passenger | Baggage | |
| | | | | | Actual | checked | checked | weight | |
| Airline | Flight | | Departure | Arrival | passenger | baggage | baggage | per | Prediction |
| company | number | Flight date | station | station | number | weight | weight | person | error |
| XX | 1111 | Feb. 27, 2022 | PEK | SHA | 130 | 1400 | 1300 | 10.77 | 7.14% |
| XX | 1111 | Feb. 28, 2022 | PEK | SHA | 140 | 1500 | 1400 | 10.71 | 6.67% |
| XX | 1111 | Mar. 1, 2022 | PEK | SHA | 88 | 900 | 977 | 10.23 | 8.56% |
| XX | 1111 | Feb. 27, 2022 | PEK | CAN | 135 | 1400 | 1350 | 10.37 | 3.57% |
| XX | 1111 | Feb. 28, 2022 | PEK | CAN | 150 | 1450 | 1400 | 9.67 | 3.45% |
| XX | 1111 | Mar. 1, 2022 | PEK | CAN | 68 | 1100 | 1136 | 16.18 | 3.27% |

In the example, the checked baggage data of actual departing passengers of the current flight is obtained, and the obtained data is updated and stored in the historical checked baggage data of actual departing passengers after the current flight is closed. Thus, the historical checked baggage data of actual departing passengers corresponding to the current flight may be updated continuously as time goes, such that historical data support is provided for the checked baggage information of passengers in the future of the flight.

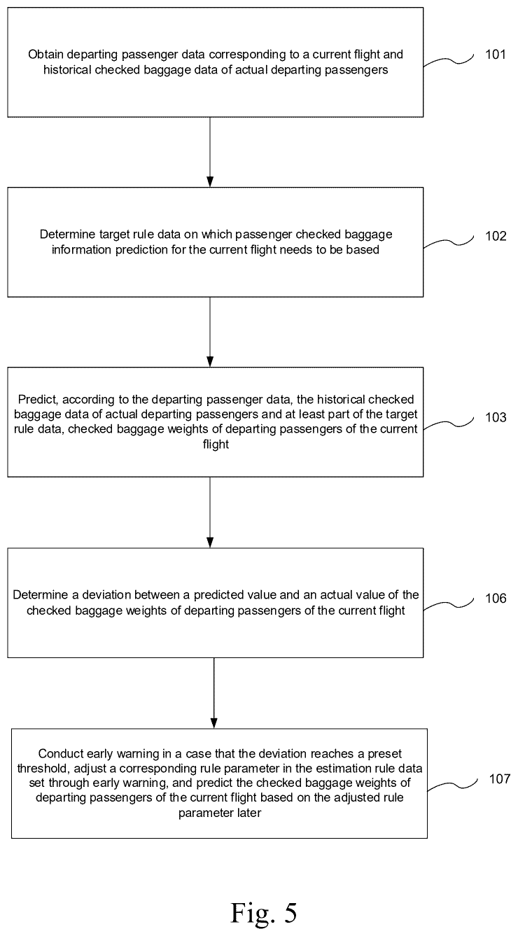

In an example, in one embodiment of this application, reference is made to a flow diagram of a method for predicting checked baggage information of passengers as shown in FIG. 5. The method for predicting checked baggage information of passengers according to the present disclosure may further include the following steps:

Step 106, a deviation between a predicted value and an actual value of the checked baggage weights of departing passengers of the current flight is determined.

Step 107, early warning is conducted in a case that the deviation reaches a preset threshold, a corresponding rule parameter in the estimation rule data set is adjusted through early warning, and the checked baggage weights of departing passengers of the current flight are predicted based on the adjusted rule parameter later.

For an instance in FIG. 2, a real-time early warning component may be further additionally arranged in the apparatus for estimating checked baggage of passengers of a loaded flight, which is implemented based on the disclosed method. Specifically, as shown in FIG. 2, the component may be used accordingly to execute processing of the example. Early warning is conducted in real time when a deviation between the predicted value and the actual value of the checked baggage weights of departing passengers reaches the preset threshold.

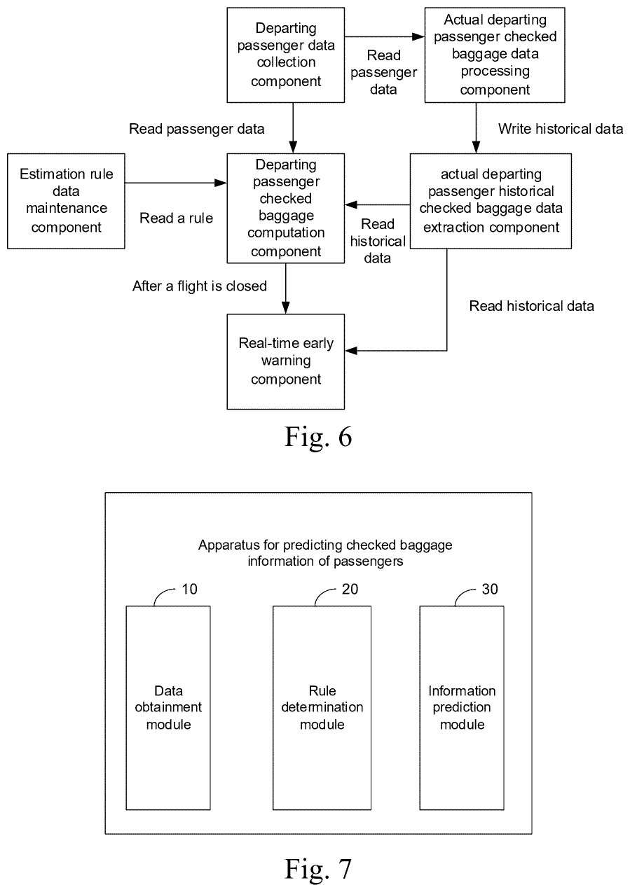

FIG. 6 further provides a schematic diagram of a component relation of all components of the apparatus for estimating checked baggage of passengers of a loaded flight in FIG. 2.

The real-time early warning component has early warning parameters (Pre warning Parameters). The early warning parameters include, but are not limited to, an airline company, a flight number, a departure station, an arrival station, a number of days, a maximum mean error, and a previous early warning date. The previous early warning date is automatically generated by a system (a current date is automatically written into the previous early warning date each time one record is generated, and then a corresponding early warning date is written as long as early warning is generated on a corresponding flight), and the other data is input by a user.

For instance, if a departure station of the flight xx1111 is in Beijing (PEK), arrival stations of baggage include SHA and CAN. Specifically, an instance is as follows:

TABLE 32

| Airline | Flight | Departure | Arrival | Number | Maximum | Previous early |
|---|---|---|---|---|---|---|
| company | number | station | station | of days | mean error | warning date |
| XX | 1111 | PEK | SHA | 5 | 5% | Jan. 1, 2022 |
| XX | 1111 | PEK | CAN | 10 | 5% | Feb. 25, 2022 |

An illustrative early warning process based on the real-time early warning component is as follows (after the Baggage History is updated by the actual departing passenger checked baggage data processing component each time after the flight is closed, the process may be automatically executed):
41) Whether early warning time is reached is determined as follows: according to the airline company, the aircraft registration number, the flight number, the departure station and the arrival station of the current flight information (Flight Info), the early warning parameters (Pre warning Parameters) are searched for, and the corresponding number of days, the maximum mean error and the previous early warning date are obtained. If a current flight date >=(the previous early warning date+days), it is indicated that the early warning time is reached, and the following process is continued. Otherwise, it is indicated that the early warning time is not reached, and the following process is ended.
42) A mean prediction error (avg Diff) is obtained as follows: according to the airline company, the flight number, the departure station, the arrival station and [flight date-days+1, flight date] of the current flight information (Flight Info), the mean prediction error is extracted from the actual departing passenger historical checked baggage data extraction component.
43) Whether early warning is needed is determined as follows: if avg Diff>avg Diff Max Value, early warning is needed, and early warning information is transmitted to a user. Meanwhile, the previous early warning date is changed to the current flight date in the corresponding Pre warning Parameters record. If avg Diff<=avg Diff Max Value, no processing is needed.

For instance, if a departure station of the flight xx1111 is in Beijing (PEK), arrival stations of baggage include SHA and CAN, and need to be determined separately:

Whether the early warning time is reached is determined as follows: in a case that the baggage arrival station is SHA, the Pre warning Parameters are searched for according to xx, 1111, PEK and SHA. If a first record in the following table is obtained, days=5, avg Diff Max Value=5%, the previous early warning date=Jan. 1, 2022, the current flight date=Mar. 1, 2022, and (the previous early warning date+days) is Jan. 6, 2022. Thus, the early warning time is reached, and subsequent determination is continued. In a case that the baggage arrival station is CAN, the Pre warning Parameters are searched for according to xx, 1111, PEK and CAN. If a second record in the following table is obtained, days=10, avg Diff Max Value=5%, the previous early warning date=Feb. 25, 2022, the current flight date=Mar. 1, 2022, and (the previous early warning date+days) is Mar. 7, 2022. Thus, the early warning time is not reached, and a subsequent process is ended.

TABLE 33

| Airline | Flight | Departure | Arrival | Number | Maximum | Previous early |
|---|---|---|---|---|---|---|
| company | number | station | station | of days | mean error | warning date |
| XX | 1111 | PEK | SHA | 5 | 5% | Jan. 1, 2022 |
| XX | 1111 | PEK | CAN | 10 | 5% | Feb. 25, 2022 |

The mean prediction error (avg Diff) is obtained as follows: subsequent determination is needed only in a case that the arrival station is SHA, such that the Baggage History is searched for according to xx, 1111, PEK, SHA, Feb. 25, 2022-3/1/2022, and the following records are obtained: avg Diff=(7.14%+6.67%+8.56%)/3=7.46%.

TABLE 34

| | | | | | | Actual | Predicted | | |
|---|---|---|---|---|---|---|---|---|---|
| | | | | | | passenger | passenger | Baggage | |
| | | | | | Actual | checked | checked | weight | |
| Airline | Flight | | Departure | Arrival | passenger | baggage | baggage | per | Prediction |
| company | number | Flight date | station | station | number | weight | weight | person | error |
| XX | 1111 | Feb. 27, 2022 | PEK | SHA | 130 | 1400 | 1300 | 10.77 | 7.14% |
| XX | 1111 | Feb. 28,2022 | PEK | SHA | 140 | 1500 | 1400 | 10.71 | 6.67% |
| XX | 1111 | Mar. 1, 2022 | PEK | SHA | 88 | 900 | 977 | 10.23 | 8.56% |

Whether early warning is needed is determined as follows: in a case that avg Diff=7.46%, avg Diff Max Value=5% and avg Diff>avg Diff Max Value, early warning information needs to be transmitted to a user. Meanwhile, the previous early warning date is changed to the current flight date in the corresponding Pre warning Parameters record. The revised record is as follows (“Mar. 1, 2022” is a revised part):

TABLE 35

| Airline | Flight | Departure | Arrival | Number | Maximum | Previous early |
|---|---|---|---|---|---|---|
| company | number | station | station | of days | mean error | warning date |
| XX | 1111 | PEK | SHA | 5 | 5% | Mar. 1, 2022 |
| XX | 1111 | PEK | CAN | 10 | 5% | Feb. 25, 2022 |

When the related parameters of the estimation rule are not set properly, an obvious deviation may be caused between the prediction result and the actual value. Based on the description, in the example, the user is asked to revise the estimation rule parameters in time through early warning. After the user revises the related rule parameters in the estimation rule data set based on the early warning information, the updated rule parameters may be used to predict the checked baggage information of departing passengers later, and the deviation between the predicted value and the actual value may be effectively reduced.

Corresponding to the method for predicting checked baggage information of passengers, the present disclosure further provides an apparatus for predicting checked baggage information of passengers. With reference to FIG. 7, the apparatus includes:
a data obtainment module 10 configured to obtain departing passenger data corresponding to a current flight and historical checked baggage data of actual departing passengers;
a rule determination module 20 configured to determine target rule data on which passenger checked baggage information prediction for the current flight needs to be based; and
an information prediction module 30 configured to predict, according to the departing passenger data, the historical checked baggage data of actual departing passengers and at least part of the target rule data, checked baggage weights of departing passengers of the current flight, such that load balancing is conducted on the current flight based on the checked baggage weights of departing passengers.

In an embodiment, the rule determination module 20 is specifically configured to:
determine, according to flight information of the current flight, a target prediction rule corresponding to the current flight in a pre-configured estimation rule data set, where the estimation rule data set includes passenger checked baggage prediction rules and related parameter data;
determine, in response to determining that the target prediction rule is a historical data prediction rule in the passenger checked baggage prediction rules, whether a historical data prediction condition is satisfied, determine, if the historical data prediction condition is satisfied, that the target rule data includes the historical data prediction rule and a corresponding rule parameter in the estimation rule data set, and determine, if the historical data prediction condition is not satisfied, that the target rule data includes static data of the checked baggage weights of passengers in the estimation rule data set; and
determine, in response to determining that the target prediction rule is a time series prediction rule in the passenger checked baggage prediction rules, whether a time series prediction condition is satisfied, determine, if the time series prediction condition is satisfied, that the target rule data includes the time series prediction rule and a corresponding rule parameter in the estimation rule data set, and determine, if the time series prediction condition is not satisfied, that the target rule data includes static data of the checked baggage weights of passengers in the estimation rule data set.

In an embodiment, the information prediction module 30 is specifically configured to:
extract, in response to determining that the target rule data includes the historical data prediction rule and the corresponding rule parameter, historical parameter data required by the historical data prediction rule from the historical checked baggage data of actual passengers, and predict the checked baggage weights of departing passengers of the current flight according to the departing passenger data, the historical parameter data, and the historical data prediction rule and the corresponding rule parameter;
extract, in response to determining that the target rule data includes the time series prediction rule and the corresponding rule parameter, historical time series parameter data required by the time series prediction rule from the historical checked baggage data of actual passengers, and predict the checked baggage weights of departing passengers of the current flight according to the departing passenger data, the historical time series parameter data, and the time series prediction rule and the corresponding rule parameter; and
predict, in response to determining that the target rule data includes the static data of the checked baggage weights of passengers, the checked baggage weights of departing passengers of the current flight according to the departing passenger data and the static data of the checked baggage weights of passengers.

In an embodiment, the time series prediction rule includes: a prediction rule represented by a pre-created ARIMA model.

The ARIMA model is obtained through model training based on a time series data sample of the checked baggage weights of departing passengers.

In an embodiment, the information prediction module 30 is further configured to: determine a total weight of checked baggage of departing passengers of the current flight and a container according to the predicted checked baggage weights of departing passengers.

In a case that the current flight is a containerized aircraft, the total weight of the checked baggage of departing passengers and the container is the sum of the checked baggage weights of departing passengers and a container weight. In a case that the current flight is a non-containerized aircraft, the total weight of the checked baggage of departing passengers and the container is the checked baggage weights of departing passengers.

In an embodiment, the apparatus further includes:
a historical data updating module configured to: obtain checked baggage data of actual departing passengers of the current flight, and update and store the obtained data in the historical checked baggage data of actual departing passengers of the current flight after the current flight is closed.

In an embodiment, the apparatus further includes:
an early warning module configured to: determine a deviation between a predicted value and an actual value of the checked baggage weights of departing passengers of the current flight; and conduct early warning in a case that the deviation reaches a preset threshold, adjust a corresponding rule parameter in the estimation rule data set through early warning, and predict the checked baggage weights of departing passengers of the current flight based on the adjusted rule parameter later.

The units/modules involved in the examples of the present disclosure may be implemented by software or hardware. A name of the unit/module does not constitute a limitation to the unit itself in some cases. For instance, a first obtainment unit may also be described as “a unit that obtains at least two Internet protocol addresses”.

The functions described above herein may be executed at least partially by one or more hardware logic components. For instance, illustrative types of hardware logic components that may be used include: a field programmable gate array (FPGA), an application specific integrated circuit (ASIC), an application specific standard product (ASSP), a system on chip (SOC), a complex programmable logic device (CPLD), etc. in a non-restrictive way.

The present disclosure further provides a computer-readable medium, which stores a computer program. The computer program includes a program code configured to execute the method for predicting checked baggage information of passengers as disclosed in the method example.

In the context of the present disclosure, a computer-readable medium (machine-readable medium) may be a tangible medium, and may include or store a program that is used by or in combination with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any one of their suitable combinations. More specific instances of a machine-readable storage medium may include an electrical connection based on one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any one of their suitable combinations.

It should be noted that the computer-readable medium described above in the present disclosure may be a computer-readable signal medium, a computer-readable storage medium, or any one of their combinations. For instance, the computer-readable storage medium may be, but is not limited to, an electronic, magnetic, optical, electromagnetic, infrared, or semiconductor system, apparatus, or device, or any one of their suitable combinations. More specific examples of the computer-readable storage medium may include, but is not limited to, an electrical connection having one or more wires, a portable computer disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any one of their suitable combinations. In the present disclosure, the computer-readable storage medium may be any tangible medium including or storing a program. The program may be used by or in combination with an instruction execution system, apparatus or device. In the present disclosure, the computer-readable signal medium may include a data signal propagated in a baseband or as part of a carrier, in which a computer-readable program code is carried. The propagated data signal may have a plurality of forms, including, but not limited to, an electromagnetic signal, an optical signal, or any one of their suitable combinations. The computer-readable signal medium may be further any computer-readable medium other than the computer-readable storage medium, and the computer-readable medium may send, propagate or transmit a program used by or in combination with the instruction execution system, apparatus or device. A program code included in the computer-readable medium may be transmitted by any suitable medium, including but not limited to: a wire, an optical cable, a radio frequency (RF) medium, etc., or any one of their suitable combinations.

The computer-readable medium may be included in the electronic device, or exist independently without being fitted into the electronic device.

The present disclosure further provides a computer program product. The computer program product includes a computer program carried on a non-transitory computer-readable medium. The computer program includes a program code configured to execute the method for predicting checked baggage information of passengers disclosed in the method example.

Particularly, according to the example of the present disclosure, the process described above with reference to each flow diagram may be implemented as a computer software program. In such an example, the computer program may be downloaded and mounted from a network through a communication apparatus, or mounted from a storage apparatus, or mounted from the ROM. When the computer program is executed by a processing apparatus, the above functions defined in the method according to the example of the present disclosure are executed.

In conclusion, according to one or more examples of the present disclosure, the present disclosure provides a method for predicting checked baggage information of passengers. The method includes the following steps:
departing passenger data corresponding to a current flight and historical checked baggage data of actual departing passengers are obtained;
target rule data on which passenger checked baggage information prediction for the current flight needs to be based is determined; and
according to the departing passenger data, the historical checked baggage data of actual departing passengers and at least part of the target rule data, checked baggage weights of departing passengers of the current flight are predicted, such that load balancing is conducted on the current flight based on the predicted checked baggage weights of departing passengers.

According to one or more examples of the present disclosure, in the method, the step that the target rule data on which passenger checked baggage information prediction for the current flight needs to be based is determined includes the following steps:
according to flight information of the current flight, a target prediction rule corresponding to the current flight in a pre-configured estimation rule data set is determined, where the estimation rule data set includes passenger checked baggage prediction rules and related parameter data;
in response to determining that the target prediction rule is a historical data prediction rule in the passenger checked baggage prediction rules, whether a historical data prediction condition is satisfied is determined, if the historical data prediction condition is satisfied, it is determined that the target rule data includes the historical data prediction rule and a corresponding rule parameter in the estimation rule data set, and if the historical data prediction condition is not satisfied, it is determined that the target rule data includes static data of the checked baggage weights of passengers in the estimation rule data set; and
in response to determining that the target prediction rule is a time series prediction rule in the passenger checked baggage prediction rules, whether a time series prediction condition is satisfied is determined, if the time series prediction condition is satisfied, it is determined that the target rule data includes the time series prediction rule and a corresponding rule parameter in the estimation rule data set, and if the time series prediction condition is not satisfied, it is determined that the target rule data includes static data of the checked baggage weights of passengers in the estimation rule data set.

According to one or more examples of the present disclosure, in the method, the step that according to the departing passenger data, the historical checked baggage data of actual departing passengers and at least part of the target rule data, checked baggage weights of departing passengers of the current flight are predicted includes the following steps:
in response to determining that the target rule data includes the historical data prediction rule and the corresponding rule parameter, historical parameter data required by the historical data prediction rule is extracted from the historical checked baggage data of actual passengers, and the checked baggage weights of departing passengers of the current flight are predicted according to the departing passenger data, the historical parameter data, and the historical data prediction rule and the corresponding rule parameter;
in response to determining that the target rule data includes the time series prediction rule and the corresponding rule parameter, historical time series parameter data required by the time series prediction rule is extracted from the historical checked baggage data of actual passengers, and the checked baggage weights of departing passengers of the current flight are predicted according to the departing passenger data, the historical time series parameter data, and the time series prediction rule and the corresponding rule parameter; and
in response to determining that the target rule data includes the static data of the checked baggage weights of passengers, checked baggage weights of departing passengers of the current flight are predicted according to the departing passenger data and the static data of the checked baggage weights of passengers.

According to one or more examples of the present disclosure, in the method, the time series prediction rule includes: a prediction rule represented by a pre-created ARIMA model.

The ARIMA model is obtained through model training based on a time series data sample of the checked baggage weights of departing passengers.

According to one or more examples of the present disclosure, in the method, after the checked baggage weights of departing passengers of the current flight are predicted, the method further includes the following step:
a total weight of checked baggage of departing passengers of the current flight and a container is determined according to the predicted checked baggage weights of departing passengers.

In a case that the current flight is a containerized aircraft, the total weight of the checked baggage of departing passengers and the container is the sum of the checked baggage weights of departing passengers and a container weight. In a case that the current flight is a non-containerized aircraft, the total weight of the checked baggage of departing passengers and the container is the checked baggage weights of departing passengers.

According to one or more examples of the present disclosure, the method further includes the following steps:
checked baggage data of actual departing passengers of the current flight is obtained, and the obtained data is updated and stored in the historical checked baggage data of actual departing passengers of the current flight after the current flight is closed.

According to one or more examples of the present disclosure, the method further includes the following steps:
a deviation between a predicted value and an actual value of the checked baggage weights of departing passengers of the current flight is determined; and
early warning is conducted in a case that the deviation reaches a preset threshold, a corresponding rule parameter in the estimation rule data set is adjusted through early warning, and the checked baggage weights of departing passengers of the current flight are predicted based on the adjusted rule parameter later.

According to one or more examples of the present disclosure, the present disclosure further provides an apparatus for predicting checked baggage information of passengers. The apparatus includes:
a data obtainment module configured to obtain departing passenger data corresponding to a current flight and historical checked baggage data of actual departing passengers;
a rule determination module configured to determine target rule data on which passenger checked baggage information prediction for the current flight needs to be based; and
an information prediction module configured to predict, according to the departing passenger data, the historical checked baggage data of actual departing passengers and at least part of the target rule data, checked baggage weights of departing passengers of the current flight, such that load balancing is conducted on the current flight based on the checked baggage weights of departing passengers.

According to one or more examples of the present disclosure, the present disclosure further provides a computer-readable medium, which stores a computer program. The computer program includes a program code configured to execute the method for predicting checked baggage information of passengers as mentioned above.

According to one or more examples of the present disclosure, the present disclosure further provides a computer program product. The computer program product includes a computer program carried on a non-transitory computer-readable medium. The computer program includes a program code configured to execute the method for predicting checked baggage information of passengers as mentioned above.

The method and apparatus for predicting checked baggage information of passengers, the computer-readable medium and the computer program product according to the present disclosure at least have the following technical advantages:
a) According to the present disclosure, computation needs to be conducted according to the historical checked baggage data of actual passengers of the flight and the departing passenger data of the current flight. Reference is made to both the historical baggage data and existing passenger data, data reference is comprehensive, and a computed value is more convincing and has a higher reference value. The predicted value is closer to the actual value, such that risks and hidden dangers posed to production security are avoided.
b) In the present disclosure, the historical checked baggage data of actual passengers of the flight and the departing passenger data of the current flight are used as input and substituted into the corresponding estimation rule for computation, and the obtained computed value of the baggage weight is fixed. The situation that different operators use the system to obtain different computed values is avoided, thus eliminating hidden dangers caused by individual differences.
c) According to the present disclosure, an early warning function is set. When the related parameters of the estimation rule are not set properly and the obvious deviation may be caused between the computation result and the actual value, the user may be asked to revise the estimation rule parameters. After the user revises the related parameters, new rule parameters may be used for computation, such that the deviation between the computed value and the actual value may be effectively reduced.

It should be noted that although the topic is described in languages of specific structural features and/or methodological logic actions, it should be understood that the defined topic is not necessarily limited to the specific features or actions described above. On the contrary, the specific features and actions described above are merely illustrative forms for implementing the defined topic. Although several specific implementation details are included in the above discussion, the details should not be construed as limiting the scope of the present disclosure. Some features described in the context of separate examples may also be implemented in combination in a single example. On the contrary, various features described in the context of a single example may also be implemented in a plurality of examples independently or in any suitable sub-combination manner.

What are described above are merely illustrative of preferred examples of the present disclosure and principles of the technology employed. Those skilled in the art should understand that the present disclosure scope of the present disclosure is not limited to the technical solution formed by a specific combination of the technical features described above, and should further cover other technical solutions formed by any combination of the technical features described above or their equivalent features without departing from the disclosed concept, for instance, the technical solution formed by interchanging the features with the (non-limitative) technical features having similar functions disclosed in the present disclosure.

1. A method for predicting checked baggage information of passengers, comprising:
obtaining departing passenger data corresponding to a current flight and historical checked baggage data of actual departing passengers;
determining target rule data on which passenger checked baggage information prediction for the current flight needs to be based; and
predicting checked baggage weights of departing passengers of the current flight, according to the departing passenger data, the historical checked baggage data of actual departing passengers and at least part of the target rule data, such that load balancing is conducted on the current flight based on the predicted checked baggage weights of departing passengers.

2. The method according to claim 1, wherein the determining target rule data on which passenger checked baggage information prediction for the current flight needs to be based comprises:
determining a target prediction rule corresponding to the current flight in a pre-configured estimation rule data set, according to flight information of the current flight, wherein the estimation rule data set comprises passenger checked baggage prediction rules and related parameter data;
determining, in response to determining that the target prediction rule is a historical data prediction rule in the passenger checked baggage prediction rules, whether a historical data prediction condition is satisfied, determining, if the historical data prediction condition is satisfied, that the target rule data comprises the historical data prediction rule and a corresponding rule parameter in the estimation rule data set, and determining, if the historical data prediction condition is not satisfied, that the target rule data comprises static data of the checked baggage weights of passengers in the estimation rule data set; and
determining, in response to determining that the target prediction rule is a time series prediction rule in the passenger checked baggage prediction rules, whether a time series prediction condition is satisfied, determining, if the time series prediction condition is satisfied, that the target rule data comprises the time series prediction rule and a corresponding rule parameter in the estimation rule data set, and determining, if the time series prediction condition is not satisfied, that the target rule data comprises static data of the checked baggage weights of passengers in the estimation rule data set.

3. The method according to claim 2, wherein the predicting the historical checked baggage data of actual departing passengers and at least part of the target rule data, checked baggage weights of departing passengers of the current flight, according to departing passenger data comprises:
extracting, in response to determining that the target rule data comprises the historical data prediction rule and the corresponding rule parameter, historical parameter data required by the historical data prediction rule from the historical checked baggage data of actual passengers, and predicting the checked baggage weights of departing passengers of the current flight according to the departing passenger data, the historical parameter data, and the historical data prediction rule and the corresponding rule parameter;
extracting, in response to determining that the target rule data comprises the time series prediction rule and the corresponding rule parameter, historical time series parameter data required by the time series prediction rule from the historical checked baggage data of actual passengers, and predicting the checked baggage weights of departing passengers of the current flight according to the departing passenger data, the historical time series parameter data, and the time series prediction rule and the corresponding rule parameter; and
predicting, in response to determining that the target rule data comprises the static data of the checked baggage weights of passengers, the checked baggage weights of departing passengers of the current flight according to the departing passenger data and the static data of the checked baggage weights of passengers.

4. The method according to claim 2, wherein the time series prediction rule comprises: a prediction rule represented by a pre-created Auto Regressive Integrated Moving Average (ARIMA) model, wherein the ARIMA model is obtained through model training based on a time series data sample of the checked baggage weights of departing passengers.

5. The method according to claim 1, wherein after the predicting the checked baggage weights of departing passengers of the current flight, the method further comprises:
determining a total weight of checked baggage of departing passengers of the current flight and a container according to the predicted checked baggage weights of departing passengers, wherein
in a case that the current flight is a containerized aircraft, the total weight of the checked baggage of departing passengers and the container is the sum of the checked baggage weights of departing passengers and a container weight, and in a case that the current flight is a non-containerized aircraft, the total weight of the checked baggage of departing passengers and the container is the checked baggage weights of departing passengers.

6. The method according to claim 1, further comprising:
obtaining checked baggage data of actual departing passengers of the current flight, and updating and storing the obtained data in the historical checked baggage data of actual departing passengers of the current flight after the current flight is closed.

7. The method according to claim 2, further comprising:
determining a deviation between a predicted value and an actual value of the checked baggage weights of departing passengers of the current flight; and
conducting early warning in a case that the deviation reaches a preset threshold, adjusting a corresponding rule parameter in the estimation rule data set through early warning, and predicting the checked baggage weights of departing passengers of the current flight based on the adjusted rule parameter later.

8. (canceled)

9. A computer-readable medium, storing a computer program, wherein the computer program comprises a program code configured to execute the method for predicting checked baggage information of passengers, when the program code runs, following actions are executed:
obtaining departing passenger data corresponding to a current flight and historical checked baggage data of actual departing passengers;
determining target rule data on which passenger checked baggage information prediction for the current flight needs to be based; and
predicting checked baggage weights of departing passengers of the current flight, according to the departing passenger data, the historical checked baggage data of actual departing passengers and at least part of the target rule data, such that load balancing is conducted on the current flight based on the predicted checked baggage weights of departing passengers.

10. A computer program product, comprising a computer program carried on a non-transitory computer-readable medium, wherein the computer program comprises a program code configured to execute the method for predicting checked baggage information of passengers, when the program code runs, following actions are executed:
obtaining departing passenger data corresponding to a current flight and historical checked baggage data of actual departing passengers;
determining target rule data on which passenger checked baggage information prediction for the current flight needs to be based; and
predicting checked baggage weights of departing passengers of the current flight, according to the departing passenger data, the historical checked baggage data of actual departing passengers and at least part of the target rule data, such that load balancing is conducted on the current flight based on the predicted checked baggage weights of departing passengers.

11. The method according to claim 2, wherein the determining a target prediction rule corresponding to the current flight in a pre-configured estimation rule data set, according to flight information of the current flight comprises:
searching for the passenger checked baggage prediction rules according to at least one of an airline company, a flight number, a departure station and an arrival station in the flight information of the current flight, and obtaining the target prediction rule.

12. The method according to claim 2, wherein the determining, in response to determining that the target prediction rule is a historical data prediction rule in the passenger checked baggage prediction rules, whether a historical data prediction condition is satisfied comprises:
extracting effective days according to an airline company, a flight number, a departure station, an arrival station and a flight date in the flight information of the current flight,
obtaining a date type according to the flight date in the flight information of the current flight;
searching for historical data prediction parameters, according to the airline company, the flight number, the departure station, the arrival station and the date type, and obtaining a minimum number of effective days of historical data; and
determining, if the effective days are greater than or equal to the minimum number of effective days of historical data, that the historical data prediction condition is satisfied.

13. The method according to claim 2, wherein the determining, in response to determining that the target prediction rule is a time series prediction rule in the passenger checked baggage prediction rules, whether a time series prediction condition is satisfied comprises:
extracting effective days predicted by day, according to an airline company, a flight number, a departure station, an arrival station and a flight date in the flight information of the current flight;
extracting effective days predicted by week according to the airline company, the flight number, the departure station, the arrival station and dates corresponding to thirty identical weeks before the flight date in the flight information of the current flight;
obtaining a date type according to the flight date in the flight information of the current flight;
searching for time series prediction parameters according to the airline company, the flight number, the departure station, the arrival station and the date type, and obtaining a minimum number of effective days of historical data; and
determining, if the effective days predicted by day are greater than or equal to the minimum number of effective days of historical data and the effective days predicted by week are greater than or equal to the minimum number of effective days of historical data, that the time series prediction condition is satisfied.

14. The method according to claim 2, further comprising:
determining the rule parameter corresponding to the historical data prediction rule in the estimation rule data set comprises:
obtaining, according to an airline company, a flight number, a departure station, an arrival station and a date type in the flight information of the current flight, historical data prediction parameters, wherein the historical data prediction parameters comprise: a percentage of historical data within 30 days, a percentage of historical data within 7 days and a percentage of historical data before a seventh day; and
obtaining, according to the airline company, the flight number, a flight date, the departure station and the arrival station in the flight information of the current flight, a booking number in the departing passenger data of the current flight.

15. The method according to claim 2, further comprising:
determining the rule parameter corresponding to the time series prediction rule in the estimation rule data set comprises:
obtaining, according to an airline company, a flight number, a departure station, an arrival station and a date type in the flight information of the current flight, time series prediction parameters, wherein the time series prediction parameters comprise: a prediction percentage by day and a prediction percentage by week; and
obtaining, according to the airline company, the flight number, a flight date, the departure station and the arrival station in the flight information of the current flight, a booking number in the departing passenger data of the current flight.

16. The method according to claim 2, further comprising:
obtaining the static data of the checked baggage weights of passengers and the departing passenger data comprises:
searching for the checked baggage weights of passengers, according to an airline company, a departure station and an arrival station in the flight information of the current flight, and obtaining baggage weights per person of different cabins; and
searching for, according to the airline company, a flight number, a flight date, the departure station and the arrival station in the flight information of the current flight, the departing passenger data, and obtaining booking numbers of different cabins.

17. The method according to claim 3, wherein the extracting, in response to determining that the target rule data comprises the historical data prediction rule and the corresponding rule parameter, historical parameter data required by the historical data prediction rule from the historical checked baggage data of actual passengers comprises:
extracting a mean baggage weight per person of historical data within 30 days, according to an airline company, a flight number, a departure station, an arrival station and a flight date in the flight information of the current flight;
extracting effective days of historical data within 7 days, according to the airline company, the flight number, the departure station, the arrival station and the flight date in the flight information of the current flight;
extracting a mean baggage weight per person of historical data within 7 days, according to the airline company, the flight number, the departure station, the arrival station and the flight date in the flight information of the current flight;
extracting effective days of historical data before a seventh day, according to the airline company, the flight number, the departure station, the arrival station and the flight date in the flight information of the current flight; and
extracting a mean baggage weight per person of historical data before a seventh day, according to the airline company, the flight number, the departure station, the arrival station and the flight date in the flight information of the current flight.

18. The method according to claim 3, further comprising:
adding, if the historical time series parameter data is missed, the historical time series parameter data through a linear difference method, comprises:
extracting, according to an airline company, a flight number, a departure station, an arrival station and a flight date in the flight information of the current flight, time series of the baggage weight per person, and adding the historical time series parameter data through the linear difference method; and
using, if there is a lack of data at a head and a tail of the historical time series parameter data, the historical time series parameter data, recent and effective data.

19. The method according to claim 5, further comprising:
searching for static data of the checked baggage density of the passenger, according to an airline company in the flight information of the current flight, and obtaining a checked baggage density of the passenger;
searching for static data of the container, according to the airline company and an aircraft registration number in the flight information of the current flight, and obtaining a container volume and a dead-weight;
computing a required container number, according to the checked baggage weights of departing passengers, the checked baggage density of the passenger and the container volume;
computing the container weight, according to the required container number and the dead-weight.
